(19) United States
(12) Patent Application Publication
(10) Pub. No.: US 2018/0057032 A1
(43) Pub. Date: Mar. 1, 2018

(54) MANUAL HEIGHT ADJUSTMENT PALLET MOVER

(71) Applicant: Magline, Inc., Standish, MI (US)

(72) Inventors: Brian Brewer, West Branch, MI (US); Chad Winters, Bay City, MI (US); Dara Hopewell, West Branch, MI (US)

(73) Assignee: Magline, Inc., Standish, MI (US)

(21) Appl. No.: 15/685,362

(22) Filed: Aug. 24, 2017

Related U.S. Application Data
(60) Provisional application No. 62/378,815, filed on Aug. 24, 2016.

(51) Int. Cl. B62B 3/06; B62B 5/06

(52) U.S. Cl. CPC B62B 3/0643; B62B 5/06

(57) ABSTRACT

A pallet mover intended to lift and move pallets. The pallet mover including a first deck, a second deck and a locking mechanism. In one embodiment, the locking mechanism includes three crescent shaped brackets with elongated slots therein. The two outermost brackets pivot to lift the first deck to raised position, and position the handle upright and at the 45-degree angles (for pushing or pulling the unit). The center bracket includes an aperture to receive the spring-loaded locking pin which locks the deck and handle portion in either the up or down position. The present pallet mover is manually driven thus having increased maneuverability and lower manufacturing cost.

### CROSS-REFERENCE TO RELATED APPLICATIONS

This application claims the benefit of U.S. Provisional Application 62/378,815 filed on Aug. 24, 2016, the contents of which are incorporated herein in its entirety.

### TECHNICAL FIELD

The present specification generally relates to a pallet mover and, more specifically, a pallet mover having manual height adjustment and configured to move half-pallets.

### BACKGROUND

The handling of material in tight spaces requires, in many instances, the use of simple hand carts that could not lift, or heavier lifting systems that were expensive and difficult to maneuver.

CooLift® or half-pallets are increasingly being used in the market. Many devices have been developed over the years to aid people in the movement and transportation of items that otherwise would be too heavy or unwieldy to move. There exists a multitude of powered devices such as cranes, forklifts, hydraulic ramps, etc. that simplify moving. A similar variety of non-powered devices also exist for people to choose from. Non-powered devices, such as pulleys, ropes, clamps, levers, hand trucks and pallet movers, are commonly available to consumers. The ease of use of contemporary pallet movers makes the pallet movers an ideal tool for transporting heavy objects and has led to the common use of hand trucks.

The wide utilization of pallet movers has caused many manufacturers to research improvements in the design. Today, industrial quality pallet movers are produced that have frames made of sturdier, tougher materials to simplify transporting appliances and other items that are too large for smaller sized pallet movers, such as those used to move half-pallets. These industrial quality pallet movers are useful for transporting exceedingly larger items, and are often even capable of handling appliances or equipment that are much greater in size than the user who is navigating the hand truck. However, these pallet movers include expensive and bulky motors required to lift the loads contained thereon.

Accordingly, a need exists for alternative a light and efficient pallet mover that can provide for both the moving and lifting of materials that is light in weight and cost efficient.

### SUMMARY

In one embodiment, a pallet mover is provided having a first deck positioned above a second deck, the first deck movable from a first position to at least a second position, the first position defined where the first deck contacts and/or rests adjacent to the second deck, the second position defined where the first deck is spaced apart from the second deck and where the first deck movable between the first position and the second position after actuation of a handle.

In another embodiment, a pallet mover is provided having a first deck and a second deck, a handle and a bracket connecting the first deck to the handle wherein the handle configured to move the first deck from a first position to a second position.

In yet another embodiment, a pallet mover is provided having a first deck and a second deck and a locking mechanism wherein the locking mechanism enable movement of the first deck.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a perspective view of the pallet mover where the first deck is in a upper position according to one or more embodiments shown and described herein;

FIG. 2 depicts an alternative perspective view of the pallet mover where the first deck is in an upper position according to one or more embodiments shown and described herein;

FIG. 3 depicts an elevational view of the pallet mover according to one or more embodiments shown and described herein;

FIG. 4 depicts a side view of the pallet mover moving between raised and lowered positions according to one or more embodiments shown and described herein;

FIG. 5 depicts a side view of the pallet mover where the upper deck in in a lower position and in a position prior to lifting the LOAD according to one or more embodiments shown and described herein;

FIG. 6 depicts a side view of the pallet mover where the upper deck is in a raised position and moving upwards so as to lift the LOAD according to one or more embodiments shown and described herein;

FIG. 7 depicts a side view of the pallet mover where the upper deck is in a raised and locked position thus lifting the LOAD according to one or more embodiments shown and described herein;

FIG. 8 depicts an exploded perspective view of the pallet mover where the upper deck is in a raised position according to one or more embodiments shown and described herein; and

FIG. 9 depicts a partially exploded perspective view of the pallet mover wherein the upper deck is in a raised position depicting a close up perspective view of the locking and movement mechanism according to one or more embodiments shown and described herein,

### DETAILED DESCRIPTION

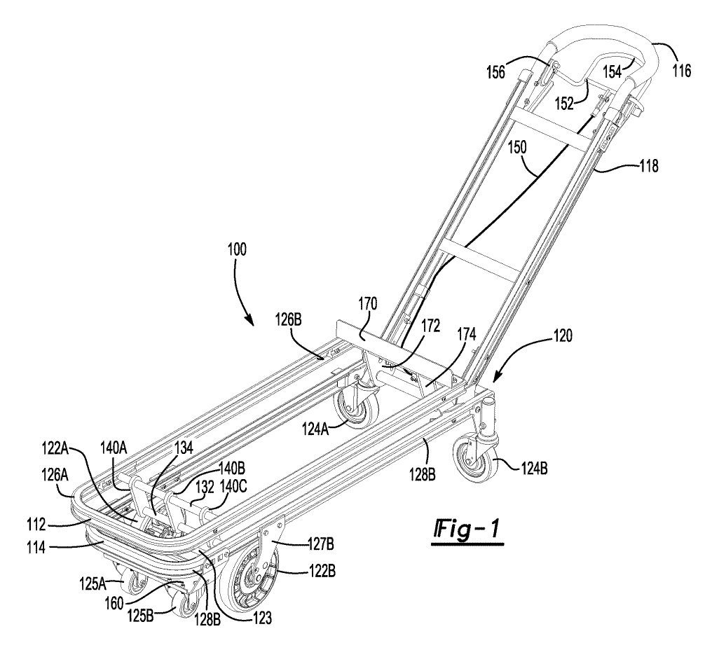

FIG. 1 generally depicts one embodiment of the pallet mover of the present application intended for both indoor and outdoor usage. The pallet mover includes a first deck, a second deck and a locking mechanism. The locking mechanism includes three crescent shaped brackets with elongated slots therein. The two outermost brackets pivot to lift the first deck to raised position, and position the handle upright and at the 45-degree angles (for pushing or pulling the unit). The center bracket includes an aperture to receive the spring-loaded locking pin which locks the deck and handle portion in either the up or down position. The present pallet mover is mechanically driven thus having increased maneuverability and lower manufacturing cost.

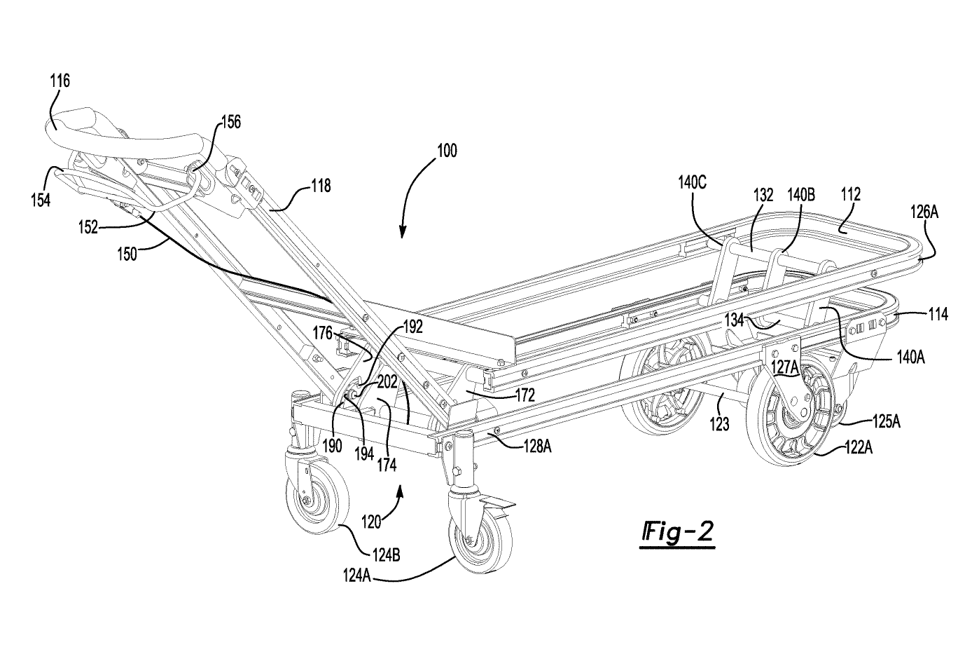

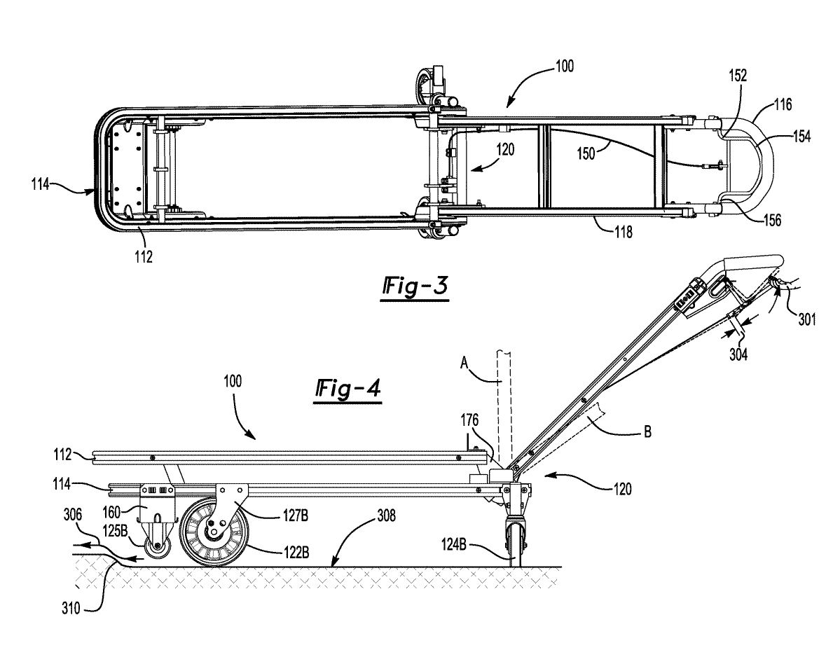

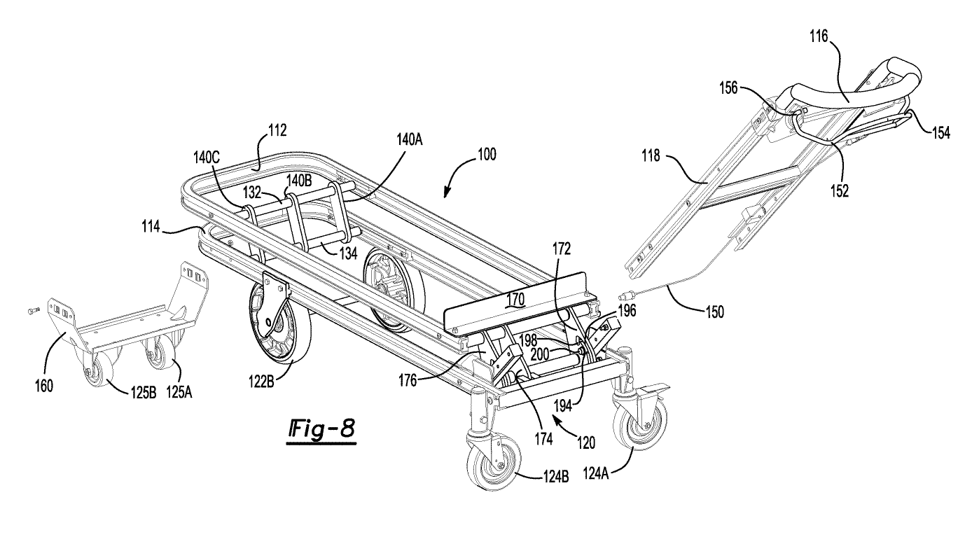

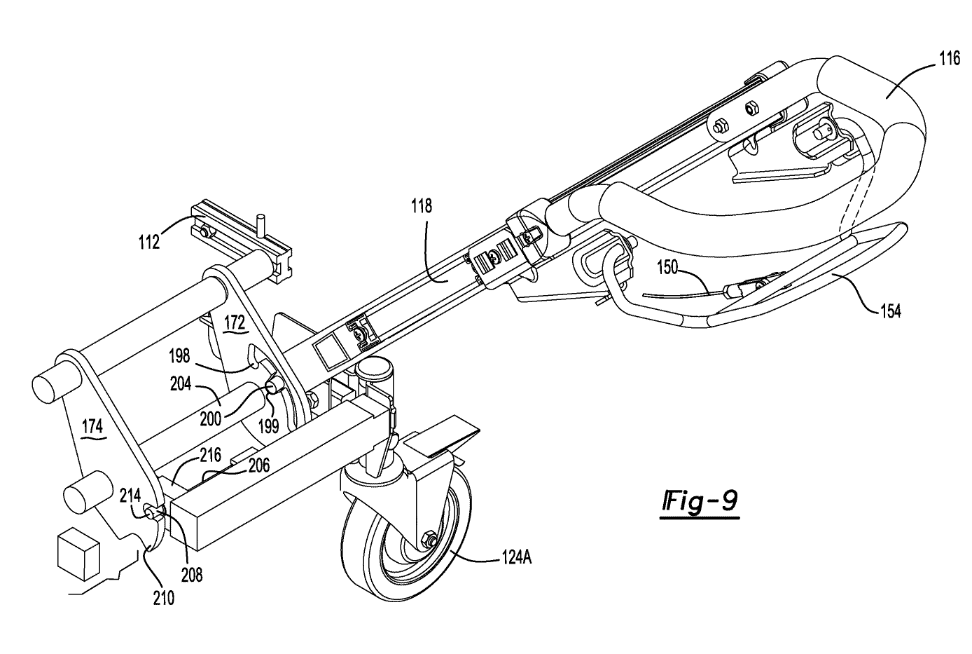

In one embodiment as illustrated in FIGS. 1-9, a pallet mover 100 is depicted having a first deck 112 and a second deck 114. The first deck 112 is positioned above the second deck 114 and is configured to move with respect to the second deck 114. The first deck 112 has a generally u-shaped configuration having a distal end 126A spaced apart from a proximal end 126B of the first deck 112. The distal end 126A has two generally curved corners forming a rounded, generally 90° angle. The two curved corners give the first deck 112 the generally u-shaped configuration. The proximal end 126B of the first deck operatively connects to a locking mechanism 120 of the pallet mover 100.

Similarly, the second deck 114 has a generally u-shaped configuration having a distal end 128A spaced apart from a proximal end 128B of the second deck 114. The distal end 128A has two generally curved corners forming a generally 90° angle. The two curved corners give the second deck 114 the generally u-shaped configuration. The proximal end 128B of the first deck operatively connects to a locking mechanism 120 of the pallet mover 100.

In alternative embodiments, all decks discussed above may be 2 generally parallel bars 4 single points, 2 generally parallel boards, or decks in any other suitable configuration capable of holding a pallet or other load. Although the present embodiments disclose the decks having generally u-shaped configurations, it should be understood that the decks may be of any suitable configuration allowing the decks to hold and transport a pallet or other load. The decks are positioned adjacent to each other and thus may be touching or slightly spaced apart. In some embodiments, the decks are spaced apart slightly by means of a stopper. In other embodiments, the upper deck rests directly on the lower deck. In even further other embodiments, the decks are very slightly spaced apart.

The pallet mover 100 includes a cross brace 132 configured to connect the first deck 112 to the second deck 114. The cross brace 132 extends between generally perpendicular portions of the first deck 112. Similarly, a cross brace 134 extends between generally perpendicular portions of the second deck 114. The cross brace 132 and the cross brace 134 includes support braces 140A, 140B extending therebetween. The support braces 140A, 140B extend between the cross brace 132 and the cross brace 134. The support braces 140A, 140B are generally evenly spaced between each other so as to support movement of the first deck 112 with respect to the second deck 114. The support braces 140A, 140B connect the cross brace 132 to the cross brace 134 so as to transfer the load thereby allowing the first deck 112 to move with respect to the second deck 114. The cross brace 132 pivotally connects to the first deck 112 at the pivot point 136. Similarly, the cross bracket 134 connects to the second deck 114 at the pivot point 138.

The grip 116 of the pallet mover 100, in the present embodiment, is connected to the handle portion 118. In the present embodiments, the grip 116 is generally u-shaped having a gripping portion. However, the grip 116 may be of any configuration allowing the user to manipulate the pallet mover 100. Adjacent to the grip 116 is an actuating mechanism or lock lever 154 for releasing the lock of a locking mechanism 120. The lock lever 154 includes a cross bar 152 and connects directly to the grip 116 and connects to the handle 118 via brackets or other connection methods at point 156. The cross bar 152 is used to stabilize and support the lock lever 154.

A cable 150 is provided extending from the lock lever 154 to the locking mechanism 120. In the present embodiment, the cable 150 is a Bowden cable or similar. The cable 150 is configured to transmit mechanical force or energy by the movement of an inner cable relative to a hollow outer cable housing. The housing is generally of composite construction, consisting of an inner lining, a longitudinally incompressible layer such as a helical winding or a sheaf of steel wire, and a protective outer covering. In other embodiments, the cable 150 may be actuated by electrical or magnetic means.

The locking mechanism generally includes a first bracket 172, a second bracket 174 and a third bracket 176. The second bracket 174 is the middle positioned bracket. The second bracket 174 connects directly to the cable 150 by means of a spring loaded locking pin 208. The locking pin 208 is actuated when a user pulls the lock lever 154. The second bracket 174 includes an apertures configured to connect with the pin 208. A bracket 216 holds the pin 208 and an end portion 206 of the cable 150. The cable 150 extends from the handle to the bracket 216 and includes bend 121 in the cable 150.

The first bracket 172 includes a slot 196. The slot 196 is elongated and extends along an upper portion of the first bracket 172. The slot 196 includes 2 indentations 198, 199. The indentations 198, 199 are configured to allow a pin 200 to rest therein when in a locked position. The indentations 198, 199 allow the handle to be locked in either a use portion or a upper locked position. In all embodiments, the handle is moveable from a locked to a use portion when repositioning the pallet mover 100.

The third bracket 176 is effectively a replica of the first bracket 172. The third bracket includes a slot 190. The slot 190 is elongated and extends along an upper portion of the third bracket 176. The slot 190 includes 2 indentations 192, 194. The indentations 192, 194 are configured to allow a pin 202 to rest therein when in a locked position. The indentations 192, 194 allow the handle to be locked in either a use portion or a upper locked position. In all embodiments, the handle is moveable from a locked to a use portion when repositioning the pallet mover 100. The slot 190 includes an end most portion 212 prohibiting further downward movement of the pin 202 and this the handle portion 118.

The handle portion 118 connects to a frame of the pallet mover 100. The handle portion 118 is pivotable with respect to the frame portion where the frame portion includes the first deck 112 and the second deck 114.

The first deck 112 first may optionally include a stopper portion 170. The stopper portion 170 includes a generally planar and vertical portion connected directly to the first deck 112. The stopper portion 170 functions to inhibit movement of a pallet or other cargo contained on the first deck 112.

In the present embodiment, the pallet mover includes two sets of wheels. The first set of wheels 122A, 122B are positioned in a forward position away from the user. The wheels 122A, 122B includes brackets which connect directly to the second deck 114. The wheels 122A, 122B may pivot with respect to the second deck 114.

Similarly, a second set of wheels 1224A, 124B are positioned in a rearward position near the handle portion 118 closest to the user. The wheels 124A, 124B are configured to pivot with respect to the second deck 114. The wheels 124A, 124B are connected directly to the second deck 114. Further, the wheels 124A, 124B are rotatable with respect to the second deck 114.

In the present embodiment, a third set of wheels 125A, 125B are provided in a position distal from the locking mechanism 120. The third set of wheels 125A, 125B are smaller wheels are intended to stabilize a heavier load on the pallet mover 100 when pivoting or turning. The set of third wheels 125A, 125B improve maneuverability and are useful when moving the pallet mover 100 up an incline or across thresholds. The third wheels 125A, 125B are held to the pallet mover 100 by means of a generally u-shaped bracket 160. The wheels 125A, 125B are also helpful when maneuvering over the ground 308 having a bump or uneven surface 310, such as illustrated by movement arrows 306.

Movement of the grip 116 and handle portion 118 is clearly illustrated in FIGS. 4-7. These figures illustrate the progressive movement of the grip 116 and handle portion 118 upon actuation of the lock lever 154. This movement illustrates the handle portion moving from a locked downward position (Position B in FIG. 4) moving forward to an upward position, a locked upright position (Position A in FIG. 4). The lock lever 154 pulled to lower the first deck 112. The lock lever 154 is pulled to release the first (or upper) deck 112. The first deck 112 in the locked down position where the handle portion 118 is locking in an upright position. The lock lever 154 is actuated so as to unlock the handle portion 118 where the handle is free to rotate within the elongates slots of the brackets. The handle portion is then unlocked and the handle portion 118 is rotated to lift the first deck 112. Actuation of movement is controlled by the lock lever 154.

FIG. 4 illustrates the pallet mover 100 wherein the handle moves from upright (Position A) to locked (Position B) positions. The Positions A and B are illustrated in phantom where the handle portion 118 is depicted in phantom in both Positions A and B. When in Position B, the pin is engaged with the indentation 194 of the bracket 176 (and in the indentation 199 of bracket 172) and the handle portion is rotated to an angle of approximately 45° so as to lift the first deck 112 to an elevated position (such as shown in FIG. 6). To facilitate actuation, a user 301 grips the lock lever 154 thereby actuating the cable 150, as illustrated by movement arrows 304.

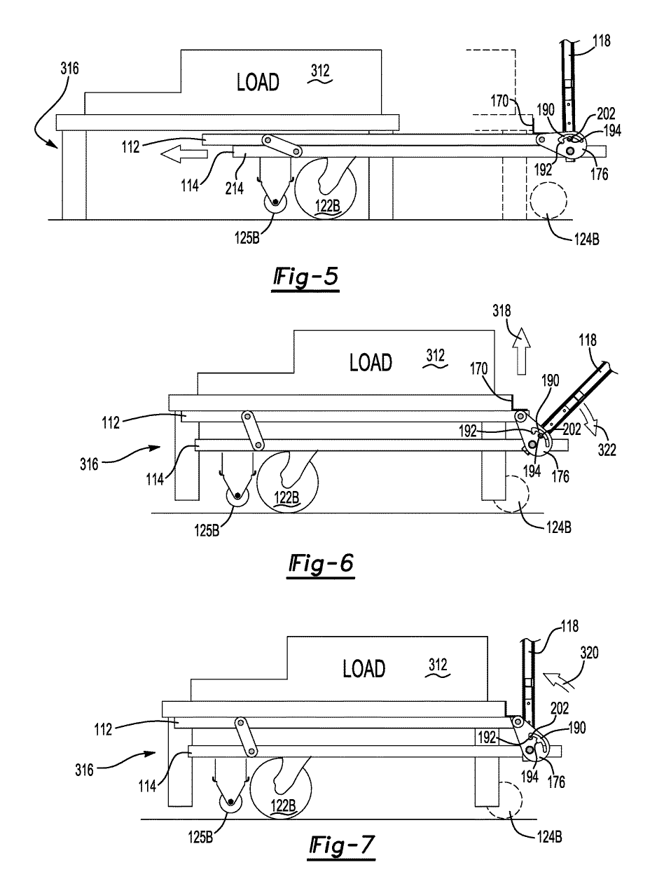

FIG. 5 illustrates the pallet mover 100 at rest prior to any movement of the first deck 112. In this position, the pin is also engaged with the indentation 194 of the bracket 176 but the bracket 176 is not rotated. The handle portion is in an upright and generally vertical position. It should be understood that the general vertical position may be at a position ranging between 120°-70° Movement arrow 314 illustrates the pallet mover 100 moving to a forward position to roll underneath the pallet 316. The pallet 316 carries the LOAD 312. Furthermore, the lowered position is a predetermined position defined as being between 0°-89°—with respect to a horizontal plane. In the present embodiment, the generally vertical position is at 90° and the lowered position is 45°. However, it should be understood that the handle can operate from −15° to 110° by changing,

FIG. 7 illustrates the load 312 in an upright configuration where the first deck 112 has elevated the load 312. In this configuration, the-pin rests within a second indentation 193 of the bracket 176. In this configuration, the handle portion is in a generally vertical position and the locking mechanism is locked.

In other embodiments, the first deck 112 may be lifted by hydraulic actuation. In this embodiment, a hydraulic actuator may be positioned between the first deck 112 and the second deck 114. The hydraulic actuator will raise the first deck 112 to space the first deck 112 away from the second deck 114. The lifting of the first deck 112 enables the pallet to be lifted off of the floor for maneuverability. This hydraulic embodiment may employ a 4-bar linkage system allowing the first deck 112 to move purely vertical, without having any lateral movement. Other mechanical and electric motors may also be used to move the first deck from a first position to a second position.

The various components of the pallet mover 100 is bolted together. In some configurations, welding other adhesive means may also be used. The components enumerated above may be made of aluminum, steel, plastic, polymers, or any other material having the strength and resiliency to perform the operations discussed above.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A pallet mover configured to lift and move pallets, the pallet mover comprising:
a first deck positioned above a second deck, the first deck movable from a first position to at least a second position, the first position defined where the first deck contacts and/or rests adjacent to the second deck, the second position defined where the first deck is spaced apart from the second deck; and
the first deck movable between the first position and the second position after actuation of a handle portion, the second position positioned high enough to elevate and move a pallet.

2. The pallet mover of claim 1 wherein the pallet mover includes a locking mechanism having at least one bracket, the locking mechanism in communication with the handle portion.

3. The pallet mover of claim 2 wherein the at least one bracket includes a slot contained therein, the slot configured to communicate with a pin, the pin configured to allow the handle to move between a vertical and a horizontal position.

4. The pallet mover of claim 1 further including an locking mechanism, the locking mechanism having a first bracket and a second bracket.

5. The pallet mover of claim 4 wherein the both the first bracket and the second bracket are pivotable about both a first cross member and a second cross member, the first cross member extending between portion of the first deck, the second cross member extending between portions of the second deck.

6. The pallet mover of claim 4 wherein the first bracket and the second bracket are movable with respect to the second deck.

7. The pallet mover of claim 4 wherein the first bracket includes a slot configured to accept a pin, the pin directly connected to the handle portion.

8. The pallet mover of claim 1 wherein the second deck is stationary.

9. A pallet mover configured to lift and move pallets, the pallet mover comprising:
a first deck and a second deck;
a handle; and
at least one bracket connecting the first deck to the handle, the handle configured to move the first deck from a first position to a second position.

10. The pallet mover of claim 9 wherein the bracket is a portion of an locking mechanism, the locking mechanism in communication with the handle portion.

11. The pallet mover of claim 10 wherein the at least one bracket includes a slot contained therein, the slot configured to communicate with a pin, the pin configured to allow the handle to move between a generally vertical and a lowered position.

12. The pallet mover of claim 11 wherein the lowered position is a predetermined position defined as being between 0°-89°—with respect to a horizontal plane.

13. The pallet mover of claim 9 further including an locking mechanism, the locking mechanism having a first bracket and a second bracket.

14. The pallet mover of claim 12 wherein the both the first bracket and the second bracket are pivotable about both a first cross member and a second cross member, the first cross member extending between portion of the first deck, the second cross member extending between portions of the second deck.

15. The pallet mover of claim 9 wherein the second deck is stationary.

16. A pallet mover configured to lift and move pallets, the pallet mover generally having a plurality of wheels, the pallet mover comprising:
a first deck and a second deck; and
an locking mechanism wherein the locking mechanism enable movement of the first deck.

17. The pallet mover of claim 16 wherein the locking mechanism includes a first bracket and a second bracket.

18. The pallet mover of claim 16 wherein the both the first bracket and the second bracket are pivotable about both a first cross member and a second cross member, the first cross member extending between portions of the first deck, the second cross member extending between portions of the second deck.

19. The pallet mover of claim 16 wherein the second deck is stationary.

20. The pallet mover of claim 16 wherein the pallet mover further includes an additional pair of wheels, the additional pair of wheels being stability wheels connected to the second deck, the stability wheels connected to a distal end of the second deck.
